(19) United States
(12) Patent Application Publication
(10) Pub. No.: US 2025/0262604 A1
(43) Pub. Date: Aug. 21, 2025

(54) DEVICE AND METHOD FOR PRODUCING SOLID PARTICLES

(71) Applicant: HTE GMBH THE HIGH THROUGHPUT EXPERIMENTATION COMPANY, Heidelberg (DE)

(72) Inventors: Andreas MUELLER, Heidelberg (DE); Volker MATHES, Heidelberg (DE); Denis HUERTGEN, Heidelberg (DE); Christoph ARIAANS, Heidelberg (DE)

(73) Assignee: HTE GMBH THE HIGH THROUGHPUT EXPERIMENTATION COMPANY, Heidelberg (DE)

(21) Appl. No.: 18/860,746

(22) PCT Filed: Apr. 20, 2023
(86) PCT No.: PCT/EP2023/060349

§ 371 Date: Oct. 28, 2024

(30) Foreign Application Priority Data
Apr. 29, 2022 (EP) 22170961.1
May 5, 2022 (DE) 20 2022 102 465.0

(51) Int. Cl. B01J 2/06

(52) U.S. Cl. CPC B01J 2/06

(57) ABSTRACT

The invention relates to a device for producing solid particles from liquid starting substances, comprising:
at least two feed containers (3.1, 3.2) for the liquid starting substances,
at least one reactor (13) in which by reaction of the liquid starting substances a suspension containing solid particles is formed or solids are deposited on seeding surfaces or seeding bodies, and
in the case of formation of a suspension, at least one filtration apparatus (25) for removing the solid particles from the suspension,
   wherein the feed containers (3.1, 3.2) are each connected via fluid connections to the reactor (13) and in the fluid connections, pumps are accommodated with which liquid from the respective feed containers (3.1, 3.2) can be conveyed into the reactor (13) and the reactor (13) is connected to the filtration apparatus (25) such that the suspension arising in the reactor (13) can flow into the filtration apparatus (25) and wherein all the system components of the device (1) are positioned in a closed housing (41).

The invention further relates to a method for producing solid particles in such a device.

### DESCRIPTION

The invention relates to a device for producing solid particles from liquid starting substances with at least feed containers for the liquid starting substances, a reactor in which a suspension containing solid particles is formed by reaction of the liquid starting substances, and at least one filtration apparatus for removing the solid particles from the suspension. The invention further relates to a method for producing solid particles from liquid starting substances in such a device.

Solid particles are produced from various materials and with various particle sizes and after further processing steps, where appropriate, are transformed into sheetlike or voluminous structures and utilized. Typical applications of such structures produced from solid particles in chemical process engineering are catalysts for heterogeneous catalysis, solid electrolytes (solid oxide ceramics) for fuel cells or electrolyzers, functionalized filter materials, electrically active catalyst materials for electrochemistry or for the storage of energy, or pigment particle synthesis.

The solid particles are produced by various processes. Common processes for the production of solid particles from solutions are, for example, precipitation reactions, spray drying or crystallization. The composition of the solution used and the choice of the process variables, more particularly temperature, pH or conductivity, and also suitable inline measuring methods, for example for particle size distribution, offer a variety of possibilities here for influencing the properties of the solids.

The product yield, and thus the profitability of the process, is substantially dependent on how high the solids fraction can be concentrated in the solution. Solids differ in their density from the density of the solution, which is a property utilized for removal from the solution after the solids have been produced in the solution. Solids with a lower density than the solution will float and can be removed from the solution by flotation; solids with a higher density can be removed by sedimentation, filtration or by centrifuging. Solids with a higher density can be forced to flotation by gassing, owing to bubble adhesion, which may also be an undesirable effect if, for example, bubbles form during the reaction. In the latter case, bubble separation is necessary before the solids are removed.

If the reaction is also to be stopped at the same time as the solution is removed, sedimentation alone followed by draining of the liquid is not sufficient, as parts of the solution remain in interstices of the solid and the reaction continues there. Solids with high density or high density difference to the solution are prone to unwanted sedimentation even before actual filtration, especially in areas where the flow of the solid-containing solution slows down or comes to a complete standstill. A depositing sedimented solution requires high shear forces at the interface between the solid sediment and the solution, which can only be applied by active flow movement, for example through a nozzle or through an agitator.

The required shear rates are not achieved in pipelines or in valves, and especially in container drainage valves.

In the production of catalyst materials or else storage materials, toxic solutions containing heavy metals are often processed into toxic solids containing heavy metals. In contrast to toxic solutions, solids cannot simply be cleaned up by flushing, especially after sedimentation or else by drying up on walls, for example in the case of pipes running empty or meniscuses above dry container inside walls. Adhesions must usually be removed by the operator personnel with protective equipment. In production and in the trial plant, this procedure is very resource-intensive and time-consuming. After each new batch or trial, the system must be completely freed of adhesions, so that the subsequent batch or trial does not suffer any carry-over by its predecessor.

Common laboratory partitioning apparatuses such as gloveboxes are poorly suited for continuous production processes owing to the airlock procedure as well as the limited accessibility of apparatuses. Complete cleanrooms hinder the operation of the system because of the necessary full protection suit.

Catalyst materials or storage materials produced from toxic solutions containing heavy metals also, for example, comprise pulverulent oxidic materials whose production is of great economic and technical importance. The development and optimization of the technical process conditions is of great interest, as the development and improvement of high-performance materials is seen as a solution to many of the challenges of the present, in order to find new technologies that can help to conserve resources better than with the existing technologies.

WO-A 2015/040005 discloses the production of electrode materials based on mixed metal oxides containing nickel, cobalt, manganese and also lithium. In addition, the materials also contain lithium and iron phosphate together with a divalent metal. To produce the electrode materials, the starting components are first combined in a precipitation reactor. The resulting suspension is then supplied in a spray dryer, in which the solid is removed from the suspension.

WO-A 2014/180743 and WO-A 2016/071219 disclose processes for the production of transition metal mixed oxides, in which spherical particles of transition metal hydroxides are initially each prepared as a precursor, in which at least one aqueous solution of an alkali metal (hydrogen)carbonate or alkali metal hydroxide and at least two aqueous solutions of transition metal salts are supplied to a reactor in which mixed transition metal carbonates, transition metal hydroxides or transition metal carbonate hydroxides are precipitated and the precipitated particles are subsequently removed.

Further processes for producing particle-containing solutions are also known from WO-A 97/41954, WO-A 2017/045817 or U.S. Pat. No. 3,124,418, for example, wherein WO-A 97/41954 describes a process for producing monodisperse silica sol from a geothermal brine, WO-A 2017/05817 a process for producing lithium-nickel-manganese-based transition metal oxide particles, and U.S. Pat. No. 3,124,418 the production of an aluminum oxide-based catalyst material. A process for the production of cobalt carbonate is known from CN-A 101376529, a process for the production of hexaaluminate by a sol-gel process from EP-A 1 390 298, or a process for the production of lithium carbonate from CN-A 106276988.

All processes use toxic solutions and/or obtain toxic solids with which contact must be avoided and which may also release toxic or corrosive vapors which must not be inhaled.

Therefore, it was an object of the present invention to provide a device and a method for producing solid particles from liquid starting substances, with which even toxic starting substances can be processed and/or toxic solids can be produced, which can also be operated continuously and in which contact with the substances used can be largely avoided during operation and also for cleaning.

This object is achieved with a device for producing solid particles from liquid starting substances, comprising:
at least two feed containers for the liquid starting substances,
at least one reactor in which by reaction of the liquid starting substances a suspension containing solid particles is formed or solids are deposited on seeding surfaces or seeding bodies, and
in the case of formation of a suspension, at least one filtration apparatus for removing the solid particles from the suspension,
   wherein the feed containers are each connected via fluid connections to the reactor and, in the fluid connections, pumps are accommodated with which liquid from the respective feed container can be conveyed into the reactor and the reactor is connected to the filtration apparatus such that the suspension arising in the reactor can flow into the filtration apparatus and wherein all the system components of the device are positioned in a closed housing.

Since the particle growth depends substantially on the number of particles already formed, it may be useful for accelerating particle formation to introduce particles into at least one of the feed containers as so-called seeding (nucleating agents) on which the nascent solid can grow. The seeding particles can consist of the growing solid or another solid, which can then also be regarded as a carrier material for the growing material. This feed container should therefore possess devices to prevent sedimentation of the particles.

Alternatively, components can also be used as seeding surfaces or seeding bodies in the reactor, so that a desired growth of layer sequences is formed on them. Bodies can have the size of conventional bulk elements-for example, an average hydraulic diameter of 0.5 to 10 mm. If the bodies are to be withdrawn as filter cakes, the size is limited to one that still allows hydraulic transport in pipelines.

Depending on the use of the device, seeding surfaces or seeding bodies may have, for example, orders of magnitude of electrode surfaces as they are customary on a laboratory scale and are utilized in electrolysis cells or fuel cells for laboratory studies. Typical surface areas for such laboratory applications are, for example, 1 cm² to 100 cm². In addition to laboratory scale use, however, the device according to the invention can also be used in industrial production. In this case, the seeding surfaces or surfaces of the seeding bodies may commonly have a size of up to 1 m², preferably of up to 0.5 m². However, for use in even larger stacks, the surfaces may also be even larger. Seeding surfaces or seeding bodies must be withdrawn directly from the reactor, in contrast to a suspension. Common reactors can be equipped with flow breakers near the inside wall of the reactor. These can also be used in a modified form as seeding surfaces. Here too, the size is limited by the inside wall of the reactor and the possibility to equip it with surfaces. The filtration at the end of the process then serves only to remove undeposited precipitated solids from the discharged filtrate.

Growing can be supported electrochemically by applying a potential to the metal sheet connected as cathode in a conductive electrolyte similar to the technique used in electroplating. The layer thickness can be estimated by the Faraday law and is proportional to the current strength. Growth also takes place here starting at crystal nuclei on the surface. Particles can also be treated in this way. Suitable geometries for seeding surfaces or seeding bodies on whose surface the crystal nuclei grow correspond, for example, to the geometry of Berty reactors.

The positioning of all the system components, i.e., the feed containers, the at least one reactor, the at least one filtration apparatus, and also the fluid connections and the pumps, in a closed housing prevents starting substances and products and by-products generated during the reaction from reaching the environment during the performance of the method.

The object is further achieved by a method for producing solid particles from liquid starting substances in such a device, comprising:
(a) charging a respective liquid starting substance in each of the feed containers;
(b) continuously gravimetrically metering the liquid starting substances into the at least one reactor;
(c) reacting the liquid starting substances to form a suspension containing the solid particles as a product or to form solid particles which are deposited on a seeding surface or a seeding body;
(d) removing the solid particles from the suspension in the filtration apparatus and withdrawing the filter basket with the solid particles contained therein or withdrawing the seeding surface or the seeding body with solid particles deposited thereon.

To prevent contact with starting substances used, the feed containers are preferably each fillable via an inlet, each inlet having a suitable interface at the housing to which a reservoir container with the starting substance for the corresponding feed container can be connected.

To fill the feed containers, they are preferably connected to a vacuum pump, so that liquid starting substance can be drawn into the feed container via the inlet connected to the reservoir container, by application of reduced pressure. This prevents possible contact with the starting substances, because the feed container is located inside the closed housing. Owing to application of reduced pressure, it is also not necessary to use a pump in the supply line through which the starting substances are conveyed and which must be opened at least for maintenance purposes, in which case contact with the starting substances conveyed by the pump cannot be prevented.

In order to be able to draw the starting substance into the feed container with a reduced pressure as constant as possible, it is also advantageous if the supply line at the top opens into the feed container. In this way, it is not necessary to adjust the target reduced pressure to the liquid column in the feed container. Instead, regardless of the liquid level in the feed container, additional starting substance is drawn from the reservoir container through the supply line into the feed container at constant reduced pressure. The vacuum pump used to generate the reduced pressure is preferably also located in the closed housing and can be managed via a management unit outside the closed housing.

The individual starting substances are passed from the feed containers into the at least one reactor. The metering of the starting substances can be volumetric or gravimetric, for example. For volumetric metering, for example, flow meters can be inserted in the connecting line from the feed container into the reactor. Alternatively or in addition, it is also possible to adjust the starting substances via the delivery rate of the pumps.

However, gravimetric metering is preferred, for which the feed containers are suspended on load cells. For the metering, the reduction in mass of the feed container is recorded. As soon as the desired amount of starting substance has been introduced into the reactor, withdrawal from the feed container is stopped. Alternatively, continuous withdrawal is also possible, for which the reduction in mass of the feed container is recorded continuously and the volume delivery of the pump into the reactor is controlled via the reduction in mass of the feed container.

In particular, in the case of gravimetric metering of the starting substances, these are preferably replenished at the exact point when no starting substance is withdrawn from the feed container. For this reason, the feed containers are preferably dimensioned such that a desired batch of the product can be produced with the starting substances charged in the feed containers and no starting substances need refilling during production.

The connecting lines from the feed containers into the reactor are preferably hoses, each having a hose spiral at the connection point at the outlet of the feed container, in order to reduce the influence of vibrations on the weight measurement and thus increase the accuracy of the metering.

In the at least one reactor, the liquid starting substances react to give the solid particles, so that a suspension containing the solid particles is formed. The reaction here can be carried out in only one reactor or in several reactors. If several reactors are used, they can be connected in parallel, so that the reaction takes place simultaneously in several reactors, or else alternatively as a reactor cascade, so that the reaction starts in a first reactor and the generated reaction mixture is transferred into another reactor in which the reaction is continued. This is repeated until the reaction mixture has been introduced into the last reactor. The use of a reactor cascade, for example, also enables the targeted addition of the starting substances, if it is desired, for example, to supply different starting substances one after the other. In this case, a different starting substance or different mixture of starting substances can be added in each reactor. This enables continuous production of the solid particles.

However, it is also possible to carry out such staggered supply of the starting substances with only one reactor; in this case, the reaction takes place batchwise, since the solid particles can be withdrawn only after addition of the last starting substance and therefore continuous operation is not possible.

By a staggered supply of the starting substances, it is possible, for example, to produce stratified solid particles, as are described, for example, in WO-A 2014/180743.

To prevent solid particles formed in the reactor from precipitating, it is preferable if a stirred tank is used as the reactor. A continuous stirred tank reactor (CSTR) is particularly preferred as the reactor. If several reactors are used as a reactor cascade, it is preferable if all the reactors used in the reactor cascade are continuous stirred tank reactors. By using the stirred tank, the suspension produced in the reactor can be stirred continuously, with the movement of the suspension preventing solid particles from precipitating and a coating forming on the reactor walls.

For increasing the solids fraction and for removing any unwanted liquid by-products generated in the reaction, it may be advantageous if liquid is drawn off from the reactor during the reaction, as described in WO-A 2014/180743, for example.

To obtain the solid particles as a product, it is necessary to remove them from the suspension. Any solid-liquid separation known to the skilled person may be used for this purpose—for example, filtration or centrifugation. Filtration is used preferably for the solid-liquid separation. For this purpose, the suspension is introduced into a filtration apparatus, in which the solid particles collect as a filter cake on a filter and the liquid of the suspension is drawn off through the filter.

To facilitate withdrawal of the filter cake containing the product, it is preferred if the filtration apparatus has a filter basket in which the solid particles collect as a filter cake and which can be withdrawn from the closed housing. The filter basket here can be withdrawn either manually via a lock in the closed housing or else automatically. For example, it is possible to design the filter basket in the form of a drawer, which sits sealed off in the housing during operation and can be pulled out of the housing for withdrawal. The filter cake containing the solid particles can then be passed on for further processing—drying, for example. In order to interrupt production only briefly, it is preferable if the filter cake and filter basket are passed on for the further processing and a new, clean filter basket is inserted into the filtration apparatus. While the subsequent batch is being filtered, the filter cake can then be removed from the filter basket and the filter basket cleaned, so that it can then be reinserted.

Alternatively, it is also possible to use a sample changer that accommodates the filter basket. In order to be able to continue operating the method after accommodation of a filter basket in the sample changer, it is further preferred if empty filter baskets are contained in the sample changer, so that an empty filter basket can be inserted into the filtration apparatus directly after the withdrawal of a filter basket containing the solid particles. This can then be repeated until all empty filter baskets have been utilized and the sample changer contains only full filter baskets. The filter baskets containing the solid particles or the entire sample changer can then be withdrawn from the housing via a lock, for example, and the sample changer can be equipped with empty filter baskets.

If a sample changer is used, it can alternatively also be designed such that it comprises a withdrawal region outside the housing, so that the filter baskets filled with solid particles are automatically transported through a suitable lock into the withdrawal region located outside the housing. Here, the filled filter baskets can be withdrawn and replaced by empty filter baskets, which are then transported into the housing via the same lock or another lock. A suitable sample changer comprises, for example, a carousel that accommodates the filter baskets. In this case, either the entire carousel can be positioned in the housing, in which case the carousel is then withdrawn each time it is equipped with filter baskets filled with solid particles, thereafter the filled filter baskets are withdrawn and replaced by empty filter baskets, and subsequently the carousel is reinserted. Alternatively and preferably, it is also possible to design the carousel such that it comprises a withdrawal region outside the housing, so that the filter baskets filled with solid particles can be transported through a lock out of the housing and withdrawn from the carousel, empty filter baskets can be placed outside the housing onto the carousel and these are moved back into the housing through a second lock, so that they can then be inserted later into the filtration apparatus.

The filter basket is preferably constructed such that the bottom of the filter basket forms the filter and the side walls of the filter basket are impermeable. A sintered frit is in this case particularly preferred for use as the filter.

In order during withdrawal of the filter basket to prevent contact with the filter cake contained therein, it is further advantageous if the filter basket has a lid which opens automatically when the filter basket is inserted into the filtration apparatus and closes automatically when the filter basket is withdrawn from the filtration machine.

The pressure difference required for filtration is preferably generated by the filtration apparatus being connected to a vacuum pump. The vacuum pump here is connected on the suction side of the filter basket, so that the suspension is drawn in the direction of the filter basket and the filtrate is drawn through the filter basket. It is particularly preferred in this case if only one vacuum pump is used both for the generation of the pressure difference for the filtration and for the drawing of the starting substances from the reservoir containers into the feed containers. For this purpose, the vacuum pump is connected, for example, via a multi-way valve to the feed containers and the filtration apparatus and, depending on the desired process, i.e., performance of filtration or supplying of starting substance, the multi-way valve is switched accordingly. This has the advantage that only one pump has to be used and thus the number of system parts to be maintained can be reduced. Of course, it is also possible alternatively to use several vacuum pumps, for example one for generating the pressure difference for the filtration and one for drawing the starting substances into the feed containers or else a separate one for each individual feed container.

The filter cake can be withdrawn directly from the filtration apparatus or it can be rinsed with a flushing liquid before withdrawal to remove still adhering reactants which can lead to an unwanted post-reaction, or other liquid impurities on the solid particles. In order to reach all the solid particles with the flushing liquid, it is preferable to swirl up the filter cake for flushing. For this purpose, a stirring element is preferably accommodated in the filtration apparatus. In order to achieve uniform mixing of the solid particles of the filter cake with the flushing liquid, the stirring element preferably has an inclined-blade stirrer, which is positioned in the filter basket. Here, it is particularly preferred if the stirrer blades of the inclined-blade stirrer have only a very small distance from the bottom of the filter basket or even have contact with the bottom of the filter basket. The distance between the stirrer blades and the inclined-blade stirrer is preferably in the range of 0 to 10 mm, more preferably in the range of 0.5 to 5 mm and in particular in the range of 1 to 2 mm. In addition to the inclined-blade stirrer in the region of the filter basket, the stirrer preferably has a further stirring element, in the form of an anchor stirrer, for example, which is arranged above the inclined-blade stirrer.

To flush the filter cake, the stirrer is set in motion so that the filter cake swirls up and the solid particles come into contact with the flushing liquid. After a predetermined flushing time, a pressure difference is generated again, in particular by application of reduced pressure on the filtrate side, and so the flushing liquid is drawn off through the filter. A new filter cake is formed from the cleaned solid particles, and can then be withdrawn from the filtration apparatus as a product. If a single flush is not sufficient, it is possible to carry out further flushes before the filter cake is withdrawn from the filtration apparatus.

Since the filter cake contains the product and must be removed regularly from the filtration apparatus, it is necessary to interrupt the filtration regularly for the withdrawal of the filter cake and, if the filter cake is flushed before withdrawal, for the flushing as well. In the case in particular of a continuously performed reaction, it is therefore preferable if a buffer container is arranged between the at least one reactor and the filtration apparatus, so that the suspension from the reactor is initially passed into the buffer container and from the buffer container into the filtration apparatus. If a reaction is carried out that requires a postreaction or the particles have to age before being removed from the suspension, the buffer container can also be utilized to carry out these processes.

In order to prevent the solid particles from precipitating from the suspension and adhering to the walls of the buffer container and forming an unwanted coating, it is preferred if the buffer container comprises a stirrer with which the suspension can be kept in motion. An axially conveying stirrer, for example an inclined-blade stirrer, is particularly preferred here as a stirrer.

In order to save on pumps for conveying the suspension and in particular also to prevent solid particles from being destroyed by shear forces that occur in the pump, it is preferred if the at least one reactor, the buffer container and the filtration apparatus are arranged one above another such that the suspension can flow under gravity from the reactor into the buffer container and further from the buffer container into the filtration apparatus, and therefore no pumps are required to convey the suspension.

Since sedimentation of solid particles and thus the formation of deposits in ongoing operation cannot be completely avoided, it is necessary after completion of a batch to clean the components of the device in which deposits can form. Cleaning after the completion of a batch also ensures that no residues from the production of the previous batch are carried over to a subsequent batch and thus adulterate the product. This is necessary particularly when the device is used for investigating reactions or when different solid particles are to be produced in successive reactions with the device. Since fine dusts in particular are respirable during manual removal of deposits and can thus during cleaning lead to a health hazard for personnel tasked with the cleaning, it is preferable if the at least one reactor, optionally the buffer container and the filtration apparatus comprise flushing nozzles with which dried deposits on inside walls can be prevented. The flushing nozzles can be used to spray a flushing liquid onto the inside walls, which can be used to flush off any adhesions. In addition, the use of flushing nozzles also allows the walls of the apparatuses to be kept wet during operation, for example by spraying solvent which is also contained in the starting substances against the walls. In this way, deposits can be prevented from forming on the walls of the apparatuses at the liquid meniscus at the liquid interface.

If the walls of the apparatus are to be cleaned after a batch, it is advantageous if the flushing liquid is sprayed against the walls with pressure from the flushing nozzles. In order to reach all points of the walls, it is further advantageous here if the flushing nozzles are axially movable and can thus be moved from top to bottom and back within the apparatus to be cleaned. Furthermore, it is preferred if rotating nozzles are used as flushing nozzles. The entire flushing process is preferably carried out fully automatically, so that it is not necessary to deploy operating personnel directly on the apparatuses.

In order to avoid the formation of deposits by sedimentation of solid particles in the individual apparatuses, it is further preferred if at the drain of the at least one reactor and optionally of the buffer container, vortex nozzles are arranged with which a shear force can be introduced into the suspension. The use of the vortex nozzles allows solid particles in the container to be able to sink downward, so that the suspension is thickened in the region of the drain preferably arranged at the bottom of the container, but the particles are kept in motion by the generated vortices, and so they do not attach themselves to the bottom and the walls of the respective apparatus.

In addition to spraying the walls with a flushing liquid, it is also possible to flood the containers with a flushing liquid and move it in the containers, for example by stirring or by using the vortex nozzles. The flushing liquid is then taken off through the filtration apparatus and can be analyzed to determine the progress of cleaning. Taking off the flushing liquid through the filtration apparatus offers the further advantage that solid detached by flushing is collected as a filter cake in the filter basket and, if it is not contaminated and meets the required specifications, can likewise be recovered as a product. On the other hand, even when the cleaned solid can no longer be utilized, the flushing liquid can be utilized for a further flush.

In order to continue to record the cleaning progress without looking directly into the system components, it is preferable to include sensors that can be used to monitor the cleaning. Suitable sensors for monitoring the cleaning are, for example, the measurement of the conductivity of the effluent filtrate or the use of cameras with which images of the cleaned surfaces are taken and which are evaluated by suitable image detection or else alternatively monitored by operating personnel.

By using the flushing nozzles and vortex nozzles in conjunction with the sensors for monitoring the cleaning, it is possible to operate the system for a longer period of time and also perform several different reactions without having to open the housing, to avoid operating personnel being exposed to the substances used or produced in the method.

In order to avoid subsequent processes for the necessary increasing of the process yield and associated additional contamination-prone interfaces with additional apparatuses, it is preferred if the process regime is intensified in the device for producing solid particles. This can be done in particular by targeted utilization of the sedimentation in the containers, for example the reactor or the buffer container, by adjusting the shear rate by active flow movement, for example by stirring or the use of vortex nozzles, such that solid sedimentation without particle movement is prevented but loose sedimentation with particle movement is possible. In this way, differential velocities can be generated between the solution and the solid particles, which hold the solid particles in suspension, where the residence time of the solid particles can be set separately from the residence time of the solution in which the solid particles move. This also allows the structure of the solid particles to be specifically influenced and the solids fraction in the solution and thus the process yield to be increased. Layer sequences on the solid particles are also possible by metering the different starting substances in portions.

The particle size and the particle size distribution, which can be characterized by a cumulative size distribution curve, for example, can be set in a feedback loop. For this purpose, the solid particles are measured, for example, directly in the reactor with a probe or in a flow cell in a reactor circuit or at a point after the reactor, and the starting substances, the pH, the temperature and/or the stirrer speed are adjusted accordingly.

To prevent the reactor contents from overheating due to the stirring, it is also preferred to measure the torque at the stirrer drive. This provides an indication of the stirring energy introduced that must not be exceeded.

It is preferable to withdraw samples at regular intervals in order to record the progress of reaction. For this purpose it is possible, for example, at the reactor outlet and/or at the outlet of the buffer container, to provide a valve which can be switched such that an assigned sample vessel is filled. The valve is then closed again. In the case of the continuously operating reactor, from which product is therefore also withdrawn continuously, the valve at the outlet is preferably arranged such that in operation it opens the connection to the buffer container or, if a buffer container is not used, to the filtration apparatus and, for sampling, this connection to the valve is briefly closed and a connection to a sample vessel is opened. Once the desired sample quantity has been withdrawn, the valve is switched again so that the connection to the sample vessel is closed and the connection to the buffer container or to the filtration apparatus is opened.

Accordingly, a valve may also be provided at the outlet of the buffer container, with which either the connection to the filtration apparatus can be opened or the connection to a sample vessel.

In order to be able to withdraw several samples without opening the housing each time or inserting the sample vessel through a lock for sampling, it is preferred to use a sample changer for the sampling. This changer is preferably structured as described above for the sample changer for the filter baskets. With particular preference, the sample changer here as well is a carousel, which can either be removed completely from the housing after all the sample vessels have been filled, or which in particular comprises a withdrawal region outside the housing, so that filled sample vessels can be transported with the carousel through a first lock out of the housing and empty sample vessels can be transported back into the housing through another lock, so that regular sampling is possible without opening the housing and also more samples can be taken than the carousel has places for sample vessels.

Regardless of whether a valve is provided for sampling on the reactor or on the filtration apparatus, it is preferably always also switchable in such a way that the outlet from the reactor or the buffer container can be closed. Even if no sampling is intended, there is preferably a valve or a tap included with which the outlet from the reactor and the buffer container can be closed.

In order to prevent the valve or the tap for closing the outlet from the reactor or the buffer container from clogging due to sedimented solids, it is further advantageous to provide a flushing nozzle with which the valve or the tap can be flushed. Flushing is performed each time the reactor or the buffer container is completely empty, to prevent flushing solution used for flushing from entering the suspension. If the liquid phase of the suspension can be utilized as the flushing solution, it is also possible as and when required to flush when the reactor or the buffer container is not completely empty, as in this case no unwanted components can enter the suspension.

In order to avoid contact with the samples, it is further preferred if these can also be evaluated automatically, with the evaluation here preferably also taking place within the housing. Alternatively, sampling is designed so that the sample vessels are automatically closed after the sample has been accommodated, and can then be withdrawn from the housing for analysis via a suitable lock.

The device according to the invention and the method according to the invention are used preferably for the production of catalyst materials or electrode materials. Acids or alkalis are often used as starting substances for these, and the solid particles produced are also often toxic.

Owing to the aggressiveness of acids or alkalis that are used, it is necessary to manufacture the system components that come into contact with them from an inert material or to coat them with such a material. In particular, the feed containers, the reactor and connecting lines are made of a material which is chemically inert to the liquid starting substances and substances formed in the production of the solid particles, or are coated with such a material.

In particular, when using strong alkalis such as alkali metal hydroxide or when using solutions of transition metal salts such as in the production of spherical particles of transition metal carbonates, transition metal hydroxides or transition metal carbonate hydroxides as described in WO-A 2014/18743, no components made of a metal can be used, because the latter is decomposed by the starting substances, and metals dissolved from the components can lead to unwanted contamination of the product.

In order to prevent such damage to the system components, the feed containers, the at least one reactor and the buffer container are preferably manufactured from glass. As an alternative to manufacture from glass, it is also possible to manufacture the containers from a plastic inert to the starting substances or from steel or stainless steel and to coat them with a coating of a material inert to the starting substances, for example a suitable plastic or else enamel. However, it is preferable to manufacture the containers from glass. The connecting lines are preferably pipelines or hoses made of a plastic inert to the starting substances used, for example of polytetrafluoroethylene (PTFE), polyetheretherketone (PEEK), polypropylene (PP), polyethylene (PE) or mixtures thereof and especially preferably of PTFE.

Pumps which are used for conveying the starting substances or else for conveying the suspension containing the solid particles, or intermediate products, are preferably peristaltic pumps or membrane pumps, wherein the hoses of the peristaltic pump and the membrane of the membrane pump are also made of polymers inert to the starting materials used. The same polymers can be used here as described above for the connecting lines.

Exemplary embodiments of the invention are represented in the figures and are elucidated in detail in the description that follows.

In the figures,

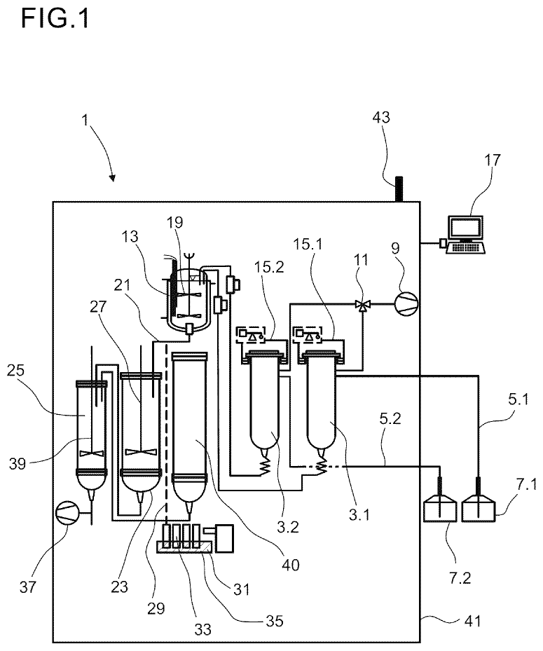

FIG. 1 shows a schematic representation of a device of the invention for producing solid particles;

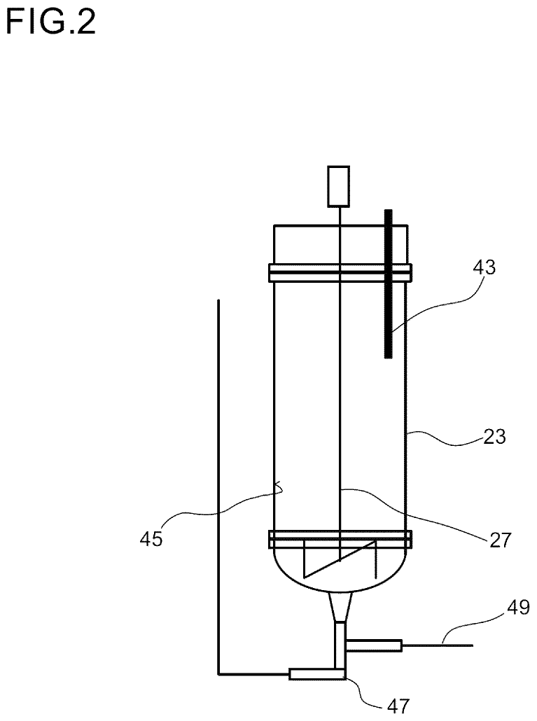

FIG. 2 shows a buffer container as used in the device for producing solid particles;

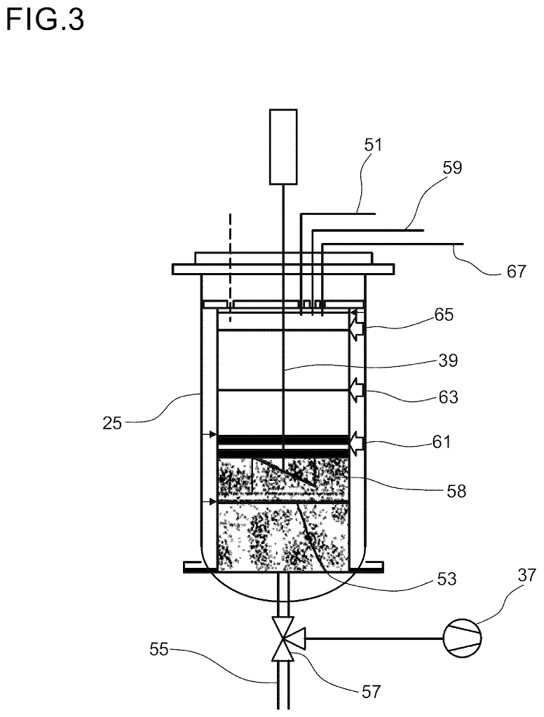

FIG. 3 shows a filtration apparatus as used in the device for producing solid particles;

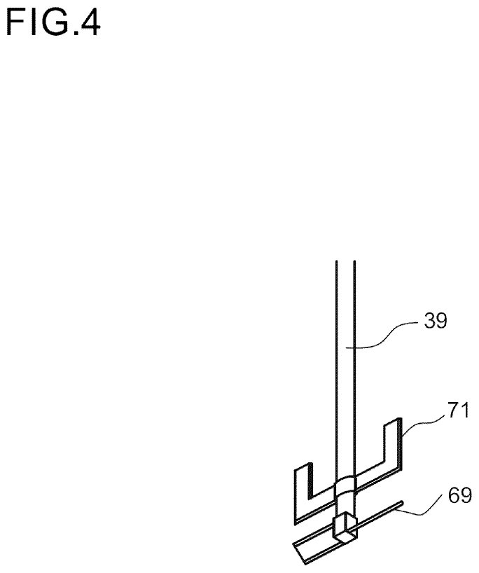

FIG. 4 shows a stirrer inserted in the filtration apparatus.

A device 1 for producing solid particles from liquid starting substances comprises a plurality of feed containers 3.1, 3.2, in which the liquid starting substances are charged, wherein a starting substance is held in each feed container 3.1, 3.2, so that the number of feed containers 3.1, 3.2 is dependent on the number of liquid starting substances.

The feed containers 3.1, 3.2 can each be connected via a connecting line 5.1, 5.2 to a reservoir container 7.1, 7.2, in which the respective starting substance is stocked. For filling, reduced pressure is applied to the feed containers 3.1, 3.2 and conveys the respective starting substance from the reservoir container 7.1, 7.2 into the feed container 3.1, 3.2. In order to apply the reduced pressure to the reservoir containers 7.1, 7.2, these are connected to a vacuum pump 9. For individual filling of the feed containers 3.1, 3.2, a valve 11 is provided which can be switched such that in each case the reduced pressure is applied only to the feed container 3.1, 3.2 that is to be filled. If several feed containers 3.1, 3.2 are to be filled, this is preferably done one after the other, so that only one feed container 3.1, 3.2 is ever being filled. This means that a vacuum pump 9 with a lower delivery rate can be utilized. In addition, a more precise filling of the feed containers 3.1, 3.2 is possible in this way.

In order to be able to draw the starting substance into the feed container 3.1, 3.2 with a constant reduced pressure over the entire filling time and not to have to overcome the hydrostatic pressure built up by the liquid column with increasing filling height in the feed container 3.1, 3.2, the connecting lines 5.1, 5.2 open in each case in the upper region, preferably above the predetermined maximum filling height, into the feed container 3.1, 3.2.

The starting substances are conveyed from the feed containers 3.1, 3.2 into a reactor 13. In the reactor 13, the liquid starting substances react to form solid particles, so that a suspension forms in the reactor 13.

For the exact metering of the starting substances, each feed container 3.1, 3.2 is suspended on a load cell 15.1, 15.2. The load cells 15.1, 15.2 allow gravimetric metering of the liquid starting substances into the reactor 13. Depending on the reaction that is carried out in the reactor and thus depending on the solid particles to be produced, the individual starting substances can be introduced into the reactor 13 in an individually controlled manner. This control is preferably carried out automatically with a suitable control device, for example a control software running on a computer 17.

In order to prevent solid particles from sedimenting from the suspension in the reactor 13, and at the same time to obtain a homogeneous mixture of the liquid starting substances, the reactor preferably comprises a mixing device, for example a stirrer 19. With particular preference, the reactor 13 is a continuous stirred tank reactor (CSTR) or a reactor cascade of several reactors connected in series, where in this case too, preferably each reactor of the reactor cascade is a CSTR.

During continuous operation of the reactor 13, the suspension generated in the reactor is drawn off continuously via a drain line 21 and passed into a buffer container 23. From the buffer container 23, the suspension is then supplied to a filtration apparatus 25, in which the solid particles are removed from the suspension. When the filtration is carried out batchwise, the buffer container 23 serves in particular also as an intermediate store for the continuously supplied suspension, which is then withdrawn batchwise from the buffer container 23 and supplied to the filtration apparatus 25. Alternatively or additionally, the buffer container 23 can also be used to give the solid particles sufficient time for a post-reaction, if, for example, the reaction proceeds slowly and the dwell time in the reactor 13 is not sufficient to achieve complete conversion of the starting substances.

In order to prevent solid particles from sedimenting in the buffer container 23 and forming an unwanted coating, the buffer container 23 comprises a stirrer 27 with which the suspension is stirred and the solid particles are kept in motion in the liquid phase.

To police the progress of reaction and analyze the solid particles produced, it is preferred when, as shown here, a sample line 29 branches off from the drain line 21. Samples can be taken via the sample line 29 and supplied to an analysis unit 31. In this case, it is particularly preferred if the sample line 29 is connected with a valve to the drain line 21, where the valve in normal operation closes the sample line 29 and opens the drain line and for taking a sample closes the drain line 21 and opens the sample line 29. In this valve position, a sample is taken and then the valve is switched again such that the drain line 21 is open and the sample line 29 is closed. For the removal of another sample, the switch is then accordingly made again for a short period of time.

The individual samples taken via the sample line 29 are preferably each introduced into a sample vessel 33, with a new sample vessel 33 being utilized for each sample. For this purpose, the sample vessels 33 are located, for example, on a carousel 35, which rotates one step further after removal of a sample and positions the next, empty sample vessel 33 under the sample line 29.

The samples contained in the sample vessels 33 can either be evaluated automatically or the holder with the filled sample vessels 33 is withdrawn and replaced by a new holder with sample vessels 33 as soon as all the sample vessels 33 are filled. In this case, the analysis of the samples contained in the sample vessels 33 can also be carried out on a separate analysis unit.

In the filtration apparatus 25, the solid particles are removed from the suspension. For this purpose, a pressure difference is applied by connecting the filtrate side to a vacuum pump 37. Here, it is particularly advantageous if the device 1 comprises only one vacuum pump, with the one vacuum pump being used both for generating the pressure difference for the filtration and for generating the reduced pressure in the feed containers 3.1, 3.2. For this purpose, the filtrate side of the filtration apparatus 25 is connected not to a separate vacuum pump 37, as shown here, but instead via the valve 11 to the vacuum pump 9. The valve 11 can then be switched so that a reduced pressure is applied either to one of the feed vessels 3.1, 3.2 or on the filtrate side of the filtration apparatus 25.

Owing to the applied reduced pressure, the liquid phase of the suspension is sucked through a filter in the filtration apparatus 25, so that the solid particles collect as a filter cake on the filter and the liquid phase can be withdrawn as filtrate. For withdrawing the solid particles as a filter cake, it is preferred if the filter is formed as the bottom of a filter basket and the filter basket together with the filter cake can be withdrawn from the filtration apparatus.

In order to remove residues of liquid phase from the solid particles, it is advantageous if the filter cake can be washed before withdrawal from the filtration apparatus. To do this, the filter cake is mixed with a flushing liquid, which can be removed again as a filtrate after the flush. In order to mix the solid particles of the filter cake with the flushing liquid, the filtration apparatus preferably likewise has a stirrer 39. The flushing liquid is preferably, as shown here, accommodated in a reservoir container 40.

In order to prevent operating personnel from coming into contact with toxic starting substances or toxic product, all components of the device 1 except for the reservoir containers 7.1, 7.2 and the computer 17 are arranged in the interior of a closed housing 41. In order to access, if necessary, the components arranged in the housing 41, for example, when replacement or maintenance is required, the housing 41 preferably has an access which can be closed in a manner impervious to gas and liquid.

The gases removed from the process via the vacuum pumps 9, 37 and any other exhaust gases resulting in the process can preferably be withdrawn via an exhaust gas outlet 43 on the housing 41, with the exhaust gas outlet 43 being connected to an exhaust gas purifier in order to prevent gaseous hazardous substances drawn off from the housing 41 from being able to reach the environment.

In order to prevent unwanted deposits from forming on the containers in which suspension is located—that is, the reactor 13, the buffer container 23 and the filtration apparatus 25—these containers preferably each have at least one flushing nozzle, which is arranged above the maximum liquid level, and via which a flushing liquid can be sprayed onto the walls of the containers to form a liquid film on them and thus prevent solid particles from depositing at the interface of the liquid in the respective container. Furthermore, it is preferred if, in addition to the stirrers 19, 27, 39, there are also vortex nozzles included with which the liquid in the containers can be kept in motion to avoid deposits.

When a batch is finished, it is also preferred if the system components can be cleaned automatically, for example by spraying liquid under pressure onto the inner walls of the containers via the flushing nozzles to remove possible deposits. Furthermore, it is also possible to flood the containers with a flushing liquid and to move it, for example by means of the stirrers 19, 27, 39 or with the aid of vortex nozzles and in this way to remove possible deposits by flushing. The entire flushing process is carried out fully automatically in order to prevent operating personnel from coming into contact with components used in the method.

Once the flushing process has been ended, a new batch can then be started.

If the same flushing liquid can be used for cleaning the system components as for cleaning the filter cake, it is preferably also withdrawn from the reservoir container 40, which for that purpose is connected not only to the filter apparatus but also to the reactor 13.

FIG. 2 shows a buffer container 23, as it can be used in the device shown in FIG. 1.

The suspension from the reactor 13 is introduced into the buffer container 23 via an inlet 43. In the buffer container 23, the suspension is kept in motion with the stirrer 27 to prevent solid particles from precipitating out of the suspension and forming an unwanted coating on the inner walls 45 of the buffer container 23. For this purpose, any suitable stirrer can be used, with the stirrer with particular preference being an axially conveying stirrer. Axially acting inclined-blade stirrers are particularly suitable.

At the bottom of the buffer container 23 is an outlet 47, through which the suspension can be withdrawn from the buffer container 23 and supplied to the filtration apparatus 25. Opening at the outlet 47 preferably is a flushing line 49, through which flushing liquid can be introduced from below into the buffer container 23, in order to be able to flush it after completion of a batch. Alternatively or in addition to the flushing line 49, a sample line can also branch off from the outlet 47. Samples can be taken via the sample line in order to analyze the suspension withdrawn from the buffer container 23 before it is supplied to the filtration apparatus 25.

FIG. 3 shows a filtration apparatus 25, as it can be used in the device 1 of the invention for the production of solid particles.

The filtration apparatus 25 is filled via an inlet line 51 with the suspension to be separated. In this case, the inlet line 51 is generally the line which is connected to the outlet 47 of the buffer container 23, so that the suspension from the buffer container 23 can be passed into the filtration apparatus 25. The filtration apparatus 25 can be operated continuously or batchwise, with batch operation being preferred. For this purpose, the filtration apparatus 25 is filled with the suspension and reduced pressure is applied on the filtrate side, i.e., below a filter 53. For this purpose, the filtrate side is connected to the vacuum pump 37. By applying the reduced pressure, a pressure difference is generated, by which the liquid phase of the suspension is drawn through the filter 53. The solid particles contained in the suspension collect on the filter 53 and form a filter cake. The liquid phase is withdrawn from the filtration apparatus as a filtrate via an outlet 55 and can be supplied to a processing facility if rational processing of the filtrate is possible. Alternatively, the filtrate can also be supplied to an appropriate disposal facility.

As soon as the liquid phase of the suspension has been drawn off as a filtrate, a moist filter cake, which still contains residues of the liquid phase, remains on the filter 53. Since the liquid phase can still contain starting substances and in particular reactants, it is necessary to flush the solid particles remaining as filter cake in order to remove the residues of the liquid phase. For this purpose, the outlet 55 is closed with a valve 57 after the entire filtrate has been drawn off. A flushing liquid is then introduced into the filtration apparatus 25 via a flushing line 59. With the aid of the stirrer, the filter cake formed on the filter 53 is swirled up again, so that all the solid particles come into contact with the flushing liquid and so the remaining liquid phase of the suspension can be washed off. After a predetermined stirring time, the stirring is ended again and the valve 57 is switched such that a reduced pressure can be applied again on the filtrate side. This draws off the flushing liquid as a filtrate and leaves behind the flushed solid particles as a cleaned filter cake on the filter 53. If it is not possible to flush the entire liquid phase of the suspension from the solid particles in a single flush, the flushing process can be repeated one or more times.

To determine the progress of flushing and in particular to examine whether starting substances are still being washed off with the flushing liquid and thus still there must be starting substance adhering to the solid particles, it is also preferred if the flushing liquid is analyzed for residues of the starting substances after the end of a flushing cycle. For this purpose, a probe is preferably placed at the outlet 55 of the flushing liquid from the filtration apparatus 25, with which the flushing liquid can be analyzed for residues. Suitable probes are, for example, probes for measuring conductivity in the flushing liquid. A low conductivity is then an indicator of a low load of metal salts. As soon as no residues are found any longer, the solid particles are sufficiently cleaned and can be withdrawn from the filtration apparatus 25. For this purpose, it is particularly preferred if the filter 53 is a bottom of a filter basket 58, which can be withdrawn together with the filter cake formed on the filter 53. The walls of the filter basket 58 are preferably impermeable and only the bottom of the filter basket 58 acts as a filter 53.

Regardless of whether the filtration is carried out continuously or batchwise, it is also preferred if the filtration is repeated long enough or often enough for the filter cake to reach a desired height. In continuous filtration, suspension here is supplied until the filter cake has reached the desired height; in batchwise filtration, suspension is supplied again after removal of the liquid phase of a batch, the liquid phase is removed, and this is repeated often enough for the filter cake to reach the desired height. If the filter cake is to be flushed, it is preferably only flushed, even in batchwise filtration, when the filter cake has reached the desired height, as otherwise the already cleaned solid particles of the previous filtrations become contaminated again with the liquid phase.

In order to determine whether the filter cake has reached the desired height, a lower fill level sensor 61 is preferably provided, which is arranged in such a way that it can be used to detect the desired height of the filter cake. Furthermore, it is preferred if a second fill level sensor 63 is included, with which the desired fill level of the suspension or the flushing liquid can be detected when the filtration apparatus 25 is filled with the suspension or the flushing liquid. An upper fill level sensor 65 can be used to detect the maximum permissible fill level in order to prevent the filtration apparatus from being overfilled. Optionally, the lower fill level sensor 61 can also be utilized to set a lower level of the cleaning fluid drawn off by suction. This prevents premature drying of the filter cake between the cleaning steps.

After conclusion of the filtration of a batch or if impurities have formed on the filtration apparatus 25, the latter is preferably cleaned. For this purpose, a supply line 67 is provided for a cleaning fluid. This can be used to flood the filtration apparatus for cleaning. For cleaning, the filtration apparatus 67 is preferably filled up to the maximum filling level, which is detected with the upper fill level sensor 65. Subsequently, the cleaning fluid in the filtration apparatus is set in motion with the aid of the stirrer 39 and optionally vortex nozzles not shown here, so that the impurities are washed off from the walls of the filtration apparatus 25 with the generated shear forces. Solid impurities are then collected in the filter basket and, if the product is still utilizable, can be further processed and utilized as a product. Alternatively, the solid impurities are withdrawn with the filter basket and disposed of.

To clean the filter cake, it is necessary to completely swirl up the filter cake so that the flushing liquid can flow around and flush all the solid particles of the filter cake. For this purpose, a stirrer 39 is preferably used, as shown in FIG. 4.

The stirrer 39 preferably has stirrer blades 69 positioned at the lower end at an angle to the horizontal, so that the lower part of the stirrer 39 is an inclined-blade stirrer. In the case of a stirrer mounted in the filtration apparatus 25, the stirrer blades 69 are preferably located with only a small distance above the filter 53 or even touch the filter 53. As a result, the solid particles which are located directly on the filter 53 are scraped off from the filter and can thus also be flushed and cleaned evenly with the flushing liquid. For uniform mixing of the solid particles with the flushing liquid, a further stirring element 71, which is preferably an anchor stirrer as shown here, is located above the stirrer blades 69 forming the inclined-blade stirrer. With this element, uniform mixing of the solid particles with the flushing liquid is achieved.

When the flushing step is ended, the stirrer is halted again to allow filtration to take place.

As soon as the solid particles are cleaned and the filter basket 58 with the filter cake is to be withdrawn from the filtration apparatus 25, the stirrer is moved upward if the filter basket 58 is to be withdrawn laterally from the filtration apparatus 25. If the filter basket 58 is withdrawn downward out of the filtration apparatus 25, it is not necessary to move the stirrer axially.

1. A device for producing solid particles from liquid starting substances, comprising:
at least two feed containers configured to store the liquid starting substances;
at least one reactor configured to receive and react the liquid starting substances to form a suspension comprising solid particles or to deposit solids on a seeding surface or a seeding body; and
optionally at least one filtration apparatus configured to remove the solid particles from the suspension if the suspension is formed;
wherein:
the feed containers are each connected via fluid connections to the reactor;
the fluid connections comprise pumps configured to convey the liquid from the respective feed containers into the reactor;
the reactor is connected to the filtration apparatus, if present, such that the suspension arising in the reactor can flow into the filtration apparatus; and
all system components of the device are positioned in a closed housing.

2. The device according to claim 1, wherein the feed containers are suspended on load cells.

3. The device according to claim 1, wherein the feed containers, the reactor, and the fluid connections are made of a material which is chemically inert to the liquid starting substances and substances formed in the production of the solid particles, or are coated with the material.

4. The device according to claim 1, wherein:
the device comprises the filtration apparatus; and
the filtration apparatus comprises a filter basket configured to collect the solid particles collect as filter cake and which can be withdrawn from the closed housing.

5. The device according to claim 1, wherein the feed containers are connected to a vacuum pump, configured to draw the liquid starting substances into each of the feed containers by application of a reduced pressure via an inlet connected to a reservoir container.

6. The device according to claim 1, wherein:
the device comprises the filtration apparatus; and
the filtration apparatus is connected to a vacuum pump configured to generate a pressure difference necessary for filtration.

7. The device according to claim 1, wherein:
the device comprises the filtration apparatus and a buffer container located between the reactor and the filtration apparatus; and
the buffer container is arranged so that the suspension can be passed from the reactor into the buffer container and then from the buffer container into the filtration apparatus.

8. The device according to claim 1, wherein the at least one reactor comprises a flushing nozzle configured to prevent formation of dried deposits on inside walls.

9. The device according to claim 1, wherein:
the at least one reactor comprises a drain and a vortex nozzle; and
the vortex nozzle is arranged at the drain of the at least one reactor and is configured to apply a shear force into the suspension.

10. The device according to claim 8, comprising sensors configured to monitor cleaning of the reactor.

11. A method for producing solid particles from liquid starting substances in the device according to claim 1, comprising:
(a) charging a respective liquid starting substance in each of the feed containers;
(b) continuously gravimetrically metering the liquid starting substances into the at least one reactor;
(c) reacting the liquid starting substances to form a suspension containing the solid particles as a product or to form solid particles which are deposited on a seeding surface or a seeding body; and
(d) removing the solid particles from the suspension in the filtration apparatus or withdrawing the seeding surface or the seeding body with solid particles deposited thereon.

12. The method according to claim 11, comprising drawing the liquid starting substances from reservoir containers into the feed containers by application of a vacuum.

13. The method according to claim 11, wherein:
reacting the liquid starting substances comprises reacting to form a suspension containing the solid particles; and
the method further comprises transferring the suspension into a buffer container and subsequently from the buffer container into the filtration apparatus.

14. The method according to claim 11, comprising drawing liquid from the reactor during the reaction.

15. The method according to claim 13, comprising spraying a liquid at walls of the reactor above a liquid level of the suspension to form a liquid film on the walls.

16. The device according to claim 7, wherein the buffer container and the filtration apparatus comprise flushing nozzles configured to prevent formation of dried deposits on inside walls.

17. The device according to claim 7, wherein:
the buffer container comprises a drain and a vortex nozzle; and
the vortex nozzle is arranged at the drain of the buffer container and is configured to apply a shear force into the suspension.

18. The method according to claim 13, comprising spraying a liquid at walls of the buffer container above a liquid level of the suspension to form a liquid film on the walls.
